(19) United States
(12) Patent Application Publication
(10) Pub. No.: US 2026/0233763 A1
(43) Pub. Date: Aug. 13, 2026

(54) METHOD AND SYSTEM FOR CONTROLLING VEHICLE BASED ON CLASSIFICATION OF ELECTRONIC TOLL COLLECTION LANE

(71) Applicant: HL Klemove Corp., Incheon (KR)

(72) Inventor: Yeongho SON, Incheon (KR)

(73) Assignee: HL Klemove Corp., Incheon (KR)

(21) Appl. No.: 19/284,023

(22) Filed: Jul. 29, 2025

(30) Foreign Application Priority Data
Feb. 12, 2025 (KR) 10-2025-0017797

(51) Int. Cl. B60W 60/00; B60W 50/14

(52) U.S. Cl. CPC B60W 60/0053; B60W 50/14; B60W 2420/403; B60W 2420/408; B60W 2520/10; B60W 2520/105; B60W 2552/05; B60W 2552/10; B60W 2552/50; B60W 2556/40

(57) ABSTRACT

A method and a system for controlling a vehicle based on Electronic Toll Collection (ETC) lane classification are provided, and the method for controlling a vehicle based on ETC lane classification according to an embodiment of the present disclosure comprises: determining whether a driving lane of an ego vehicle is an Electronic Toll Collection (ETC) lane; if the driving lane of the ego vehicle is the ETC lane, determining whether the ETC lane is a multi-lane ETC lane; and controlling operation of a highway autonomous driving (AD) system of the ego vehicle based on whether the ETC lane is the multi-lane ETC lane.

### CROSS-REFERENCE TO RELATED APPLICATION

This application claims the benefit of and priority to Korean Patent Application No. 2025-0017797 filed on Feb. 12, 2025, the entire disclosures of which are incorporated herein by reference.

### TECHNICAL FIELD

The present disclosure relates to a method and system for controlling a vehicle based on Electronic Toll Collection (ETC) lane classification. More specifically, the present disclosure relates to a method and system for controlling a vehicle based on ETC lane classification that controls the operation of a driver assistance system of the vehicle by classifying whether an ETC lane during highway driving is a multi-lane or single-lane type.

### BACKGROUND

An Autonomous Driving System recognizes the surrounding environment and determines the driving situation to control a vehicle without driver intervention, thereby providing a function to autonomously drive to a given destination.

For example, a highway autonomous driving (Highway AD) system refers to a system that comprehensively supports driving, such as maintaining vehicle spacing, vehicle speed, lane keeping, and rear-side warnings, during highway driving.

Meanwhile, determining the safety of the road on which the vehicle intends to drive is essential for the highway AD system.

Particularly, there is a significant difference between a single-lane type and a multi-lane type in autonomous driving risk at an ETC (e.g., E-ZPass, FasTrak, etc. (corresponding to a Hi-pass in Korea)) lane for automatically collecting toll fees at a tollgate. However, it is difficult to determine whether the ETC lane is single-lane or multi-lane based solely on navigation information.

Therefore, there is a need for a method and system for controlling a vehicle based on ETC lane classification that can classify whether an ETC lane in a tollgate section is single-lane or multi-lane to control the autonomous driving system of the vehicle.

### SUMMARY

The present disclosure is to solve the problems of the prior art described above, and an object of the present disclosure is to provide a method and system for controlling a vehicle based on ETC lane classification that can enhance driving stability by controlling the operation of a highway AD system through the classification of the ETC lane.

Further, an object of the present disclosure is to provide a method and system for controlling a vehicle based on ETC lane classification that can accurately determine the single-lane/multi-lane classification of the ETC lane by determining the driving lane of the ego vehicle using navigation information and high-definition map information and calculating the width of the tollgate.

However, the technical problems to be achieved by the embodiments of the present disclosure are not limited to the technical problems described above, and other technical problems may exist.

As a technical means for achieving the above technical problems, a method for controlling a vehicle based on ETC lane classification according to an embodiment of the present disclosure comprises: determining whether a driving lane of an ego vehicle is an Electronic Toll Collection (ETC) lane; if the driving lane of the ego vehicle is the ETC lane, determining whether the ETC lane is a multi-lane ETC lane; and controlling operation of a highway autonomous driving (AD) system of the ego vehicle based on whether the ETC lane is the multi-lane ETC lane.

Further, the determining of whether the driving lane is the ETC lane may comprise: determining whether the lane in which the ego vehicle is driving is the ETC lane using position information of the ego vehicle.

Further, the determining of whether the ETC lane is the multi-lane ETC lane may comprise: extracting a center line of a lane where the ego vehicle is to drive, based on the driving lane of the ego vehicle and a navigation route according to navigation information.

Further, the determining of whether the ETC lane is the multi-lane ETC lane may further comprise: detecting positions of a left road boundary and a right road boundary of a tollgate based on road boundary information; and calculating a width of the tollgate by summing a lateral distance between the center line and the left road boundary and a lateral distance between the center line and the right road boundary.

Further, the determining of whether the ETC lane is the multi-lane ETC lane may comprise: determining that the driving lane of the ego vehicle is the multi-lane ETC lane if the width of the tollgate is equal to or greater than a predetermined threshold value; and determining that the driving lane of the ego vehicle is a single-lane ETC lane if the width of the tollgate is less than the predetermined threshold value.

Further, the road boundary information regarding the left road boundary and the right road boundary may be information provided by a High-Definition Map (HD Map).

Further, the controlling of the operation of the highway AD system may comprise: controlling the highway AD system to maintain an ON state if it is determined that the driving lane of the ego vehicle is the multi-lane ETC lane.

Further, the controlling of the operation of the highway AD system may comprise: controlling the highway AD system to switch to an OFF state if it is determined that the driving lane of the ego vehicle is the single-lane ETC lane.

Further, the method may further comprise: if it is determined that the driving lane of the ego vehicle is the single-lane ETC lane, providing, by a warning apparatus installed in the ego vehicle, a notification to a driver of the ego vehicle that the highway AD system is switching to the OFF state.

Further, the method may further comprise: after providing the notification to the driver for a predetermined time, transferring control authority to the driver.

A system for controlling a vehicle based on ETC lane classification according to embodiments of the present disclosure comprises: a first sensor configured to detect surroundings of an ego vehicle; a second sensor configured to detect body information of the ego vehicle; a third sensor configured to provide navigation information and High-Definition Map (HD Map) information; and a controller comprising at least one processor and a highway Autonomous Driving (AD) system operator, wherein the controller is configured to determine whether an Electronic Toll Collection (ETC) lane is a multi-lane ETC lane if a driving lane of the ego vehicle is the ETC lane, and control operation of the highway AD system of the ego vehicle by the highway AD system operator based on whether the ETC lane is the multi-lane ETC lane.

Further, the controller may be configured to extract a center line of a lane where the ego vehicle is to drive, based on the driving lane of the ego vehicle and a navigation route according to the navigation information provided by the third sensor.

Further, the controller may be configured to: detect positions of a left road boundary and a right road boundary of a tollgate based on road boundary information from the HD Map information provided by the third sensor; and calculate a width of the tollgate by summing a lateral distance between the center line and the left road boundary and a lateral distance between the center line and the right road boundary.

Further, the controller may be configured to: determine that the driving lane of the ego vehicle is the multi-lane ETC lane if the width of the tollgate is greater than or equal to a predetermined threshold value; and determine that the driving lane of the ego vehicle is a single-lane ETC lane if the width of the tollgate is less than the predetermined threshold value.

Further, the controller may be configured to control the highway AD system operator to maintain the highway AD system in an ON state if it is determined that the driving lane of the ego vehicle is the multi-lane ETC lane, and switch the highway AD system to an OFF state if it is determined that the driving lane of the ego vehicle is the single-lane ETC lane.

Further, the first sensor may comprise at least one of a front camera, a front radar, or a corner radar, and the second sensor comprises at least one of a speed sensor or an acceleration sensor.

Further, the third sensor may comprise a navigation device configured to provide the navigation information, and a High-Definition (HD) Map configured to provide the HD Map information, and the road boundary information regarding the left road boundary and the right road boundary may be provided by the HD Map.

Further, the controller may be connected to a warning apparatus configured to provide a notification to a driver of the ego vehicle, and the controller may be configured to control the warning apparatus to provide a notification that the highway AD system is switching to the OFF state when it is determined that the driving lane of the ego vehicle is the single-lane ETC lane.

Further, the controller may be configured to control the highway AD system operator to transfer control authority to the driver after the notification has been provided for a predetermined time by the warning apparatus.

Meanwhile, in a non-transitory computer-readable recording medium that records a program for executing a method for controlling a vehicle based on ETC lane classification on a computer according to an embodiment of the present disclosure, the method comprises: determining whether a driving lane of an ego vehicle is an Electronic Toll Collection (ETC) lane; if the driving lane of the ego vehicle is the ETC lane, determining whether the ETC lane is a multi-lane ETC lane; and controlling operation of a highway autonomous driving (AD) system of the ego vehicle based on whether the ETC lane is the multi-lane ETC lane.

The above-described means for solving the problem is only exemplary and should not be construed as limiting the present disclosure. In addition to the exemplary embodiments described above, additional embodiments may exist in the drawings and the following detailed description.

According to the problem-solving means of the present disclosure described above, it is possible to provide a method and system for controlling a vehicle based on ETC lane classification that can enhance driving safety of the driver by controlling the operation of a highway AD system through the classification of ETC lanes at a highway tollgate section as multi-lane/single-lane.

Further, according to the present disclosure, through the classification of ETC lanes, it is possible to provide a method and system for controlling a vehicle that can be usefully applied for control requirements according to autonomous driving regulations or for minimizing risks in vehicle driving according to the highway AD system.

However, the effects obtainable from the present disclosure are not limited to the effects described above, and other effects may exist.

### BRIEF DESCRIPTION OF THE DRAWINGS

FIG. 1 is a control flowchart showing a method for controlling a vehicle based on ETC lane classification according to an embodiment of the present disclosure.

FIG. 2 is a control flowchart showing in more detail an embodiment of determining whether an ETC lane is multi-lane in the method for controlling the vehicle based on ETC lane classification according to the embodiment of the present disclosure.

FIG. 3 is a diagram for explaining a method of calculating a width of a tollgate in a single-lane ETC lane in the method for controlling the vehicle based on ETC lane classification according to the embodiment of the present disclosure.

FIG. 4 is a diagram for explaining a method of calculating a width of a tollgate in a multi-lane ETC lane in the method for controlling the vehicle based on ETC lane classification according to the embodiment of the present disclosure.

FIG. 5 is a control configuration diagram schematically showing a configuration of a system for controlling a vehicle based on ETC lane classification according to embodiments of the present disclosure.

### DETAILED DESCRIPTION

Hereinafter, with reference to the accompanying drawings, embodiments of the present disclosure will be described in detail so that those skilled in the art can easily practice the embodiments. However, the present disclosure may be implemented in many different forms and is not limited to the embodiments described herein. In addition, in order to clearly describe the present disclosure in the drawings, parts irrelevant to the description are omitted, and similar reference numerals are attached to similar parts throughout the present disclosure.

Throughout the present disclosure, if a part is said to be “connected” to another part, it is not only “directly connected”, but also “electrically connected” with another element in between, including cases where they are “indirectly connected”.

Throughout the present disclosure, if one member is said to be located “on”, “above”, “under”, or “below” the other member, this includes not only the case of being in contact with the other member, but also the case that another member is positioned between the two members.

Throughout the present disclosure, if a part “includes” a certain component, it does not mean excluding other components, and it does mean that it may further include other components, unless otherwise stated.

Various embodiments of the present disclosure generally relate to a method and system for controlling a vehicle based on ETC lane classification that can control the operation of an autonomous driving system according to a classification of an ETC lane at a tollgate section as single-lane or multi-lane.

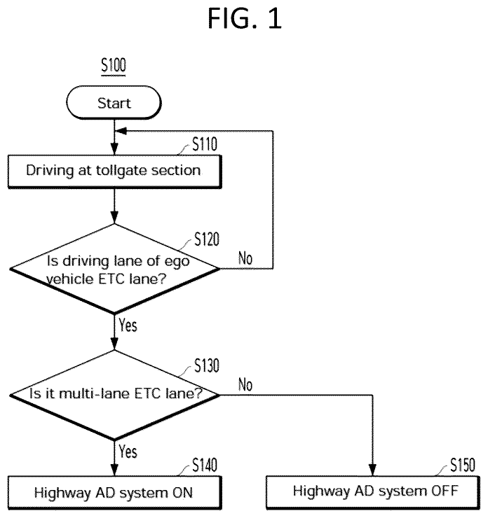

FIG. 1 is a control flowchart showing a method for controlling a vehicle based on ETC lane classification according to an embodiment of the present disclosure.

Referring to FIG. 1, the method for controlling a vehicle based on ETC lane classification S100 according to an embodiment of the present disclosure may include driving the ego vehicle at a tollgate section S110.

Here, a tollgate is a facility for collecting tolls for the use of highways or toll roads, and may refer to road facilities installed to collect tolls in a specific area.

A navigation device equipped in the ego vehicle may determine the location of the ego vehicle using a GPS sensor, and it can be confirmed whether the ego vehicle is driving at a tollgate section through navigation information provided by the navigation device. More specifically, lane numbers may be provided by the navigation information, thereby allowing confirmation of whether the ego vehicle is driving through the tollgate section.

Here, the ‘tollgate section’ may refer to an area within a predetermined distance before the point where the tollgate facility is installed. For example, if a tollgate facility is located approximately 500 m ahead, it may be determined that the ego vehicle is within the tollgate section, but the predetermined distance may be variable.

The method for controlling a vehicle based on ETC lane classification S100 according to an embodiment of the present disclosure may include determining whether the driving lane of the ego vehicle is an ETC lane S120.

Here, the Electronic Toll Collection (ETC) system is a system that allows vehicles to automatically pay tolls while continuing to drive through the tollgate on a toll road without stopping at a toll booth, using communication technology. An ETC lane may refer to a driving lane where the ETC system is applied (e.g., E-ZPass lane, FasTrak lane, etc. (corresponding to a Hi-pass lane in Korea)).

Meanwhile, whether the driving lane of the ego vehicle is an ETC lane may be determined using position information of the ego vehicle. For example, it may be determined whether the lane where the ego vehicle is driving is an ETC lane through matching position information provided by the navigation system with navigation map data, or through position information and map information provided by an HD Map (High-Definition Map).

Next, if the driving lane of the ego vehicle is an ETC lane (‘Yes’ in S120), determining whether it is a multi-lane ETC lane S130 may be performed.

Here, a multi-lane ETC lane refers to a lane configuration where a tollgate is installed to cover multiple lanes simultaneously at the toll collection point (tollgate).

Further, a single-lane ETC lane refers to a lane configuration where a tollgate is installed to cover only one lane.

Meanwhile, in the case of a single-lane ETC lane, road boundaries including the side walls of the tollgate are formed on both sides of the lane, so the risk of collision with the road boundary is higher compared to a multi-lane ETC lane when driving through the tollgate. Thus, the driving risk may be higher in the single-lane ETC lane when the ego vehicle drives according to the autonomous driving system.

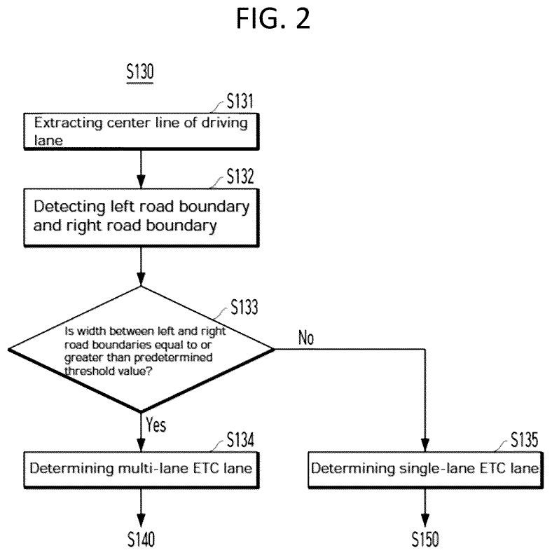

A specific embodiment for determining whether it is a multi-lane ETC lane will be described in more detail with reference to FIG. 2.

Next, controlling the operation of the highway AD system of the ego vehicle based on whether it is a multi-lane ETC lane may be performed (S140, S150).

More specifically, by determining whether it is a multi-lane ETC lane, if it is a multi-lane ETC lane (‘Yes’ in S130), the highway AD system may be controlled to be in the ON state (S140), and if it is not a multi-lane ETC lane (‘No’ in S130), it is determined to be a single-lane ETC lane, and the highway AD system may be controlled to be in the OFF state (S150).

Meanwhile, in controlling the highway AD system to the OFF state because it is determined to be a single-lane ETC lane, a notification may be provided to the driver, and control authority may be transferred from the system to the driver after providing the notification for a predetermined time.

Here, the highway AD system may refer to a system that comprehensively supports driving, such as maintaining vehicle spacing, controlling vehicle speed, lane keeping, and rear-side warnings during highway driving, and may refer to autonomous driving technology that provides convenience to the driver through functions like steering and/or acceleration/deceleration control by detecting the road environment and surrounding vehicles by sensors like cameras and/or radars.

As described above, controlling the operation of the highway AD system differently based on whether the ETC lane is multi-lane or single-lane, may be because, in the case of a single-lane ETC lane, the width of the area available for driving is narrow, making the control by the highway AD system relatively high-risk. That is, in the case of a single-lane ETC lane, the autonomous driving system may be turned OFF considering the driver's driving safety, allowing the driver to take control, thereby decreasing the risk of control by the highway AD system.

According to the embodiment of the present disclosure as described above, by controlling the operation of the highway AD system ON/OFF according to whether the ETC lane in the highway tollgate section is multi-lane/single-lane, it is possible to improve the driving safety of the driver.

FIG. 2 is a control flowchart showing in more detail an embodiment of determining whether an ETC lane is multi-lane in the method for controlling the vehicle based on ETC lane classification according to the embodiment of the present disclosure.

Referring to FIG. 2, in the embodiment of the present disclosure, the step of determining whether it is a multi-lane ETC lane S130 may include extracting the center line CL of the lane in which the ego vehicle is driving S131.

The center line CL of the lane in which the ego vehicle is driving, may be extracted through the navigation route based on the driving lane of the ego vehicle and navigation information.

Next, the step of determining whether it is a multi-lane ETC lane S130 may include detecting the left road boundary and the right road boundary in the tollgate section S132.

These left and right road boundaries may be obtained based on road boundary information provided by the HD Map. Here, the obtained road boundary information may include information regarding the positions of the left and right road boundaries.

Next, determining whether the width between the left road boundary and the right road boundary is greater than or equal to a predetermined threshold value S133 may be performed.

For example, the width between the road boundaries may be calculated by the sum of the lateral distance from the center line CL of the driving lane to the left road boundary and the lateral distance from the center line CL of the driving lane to the right road boundary. As such, the calculated width of the road boundary may be the width of the tollgate for ETC collection, and it may be determined whether this road boundary width is greater than or equal to a predetermined threshold value.

Here, the predetermined threshold value may be, for example, approximately 6 m (6 meters). However, the present disclosure is not limited thereto, and the predetermined threshold value regarding the width of the road boundary may be set differently depending on the road or country where the ego vehicle is driving.

The reason for determining whether the width between the left road boundary and the right road boundary is greater than or equal to a predetermined width (e.g., approximately 6 m) is to determine whether the lane where the ego vehicle is driving at the tollgate section is a multi-lane ETC lane or a single-lane ETC lane.

That is, if the width of the road boundary is greater than or equal to the predetermined threshold value (e.g., 6 m) (‘Yes’ in S133), it may be determined that the driving lane of the ego vehicle is a multi-lane ETC lane (S134). If the width of the road boundary is less than the predetermined threshold value (e.g., 6 m) (‘No’ in S133), it may be determined that the driving lane of the ego vehicle is a single-lane ETC lane (S135).

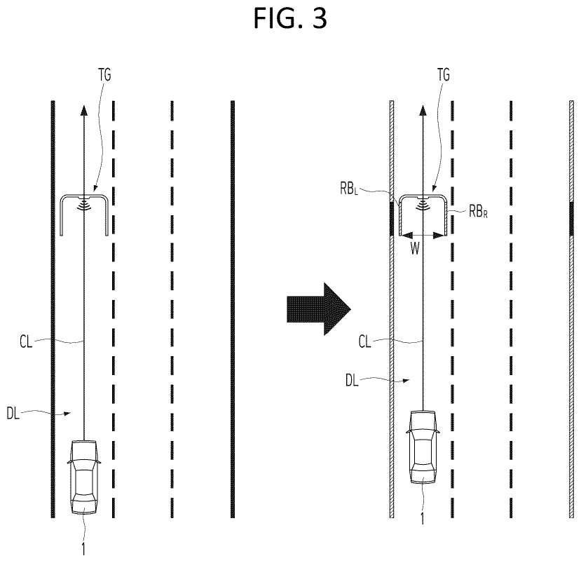

FIG. 3 is a diagram for explaining a method of calculating a width of a tollgate in a single-lane ETC lane in the method for controlling the vehicle based on ETC lane classification according to the embodiment of the present disclosure.

Referring to FIG. 3, in the method for controlling a vehicle based on ETC lane classification according to the embodiment of the present disclosure, when the ego vehicle 1 is driving on a highway, and is driving through a tollgate TG section, it may be determined using the position information whether the driving lane DL where the ego vehicle 1 is driving is an ETC lane.

Further, the center line CL of the lane where the ego vehicle is to drive may be extracted through the navigation route based on the driving lane of the ego vehicle and navigation information.

Referring to the right diagram of FIG. 3, after the center line CL is extracted, the road boundaries RB_{L}, RB_{R} of the tollgate TG section may be detected, and the width W between the road boundaries may be calculated by summing the lateral distance between the center line CL and the left road boundary RB_{L} and the lateral distance between the center line CL and the right road boundary RB_{R}.

With determining whether the calculated width W is greater than or equal to a predetermined threshold value, if it is less than the predetermined threshold value, as shown in FIG. 3, it may be determined that the ETC lane is a single-lane ETC lane, and accordingly, the highway AD system of the ego vehicle 1 may be switched to the OFF state.

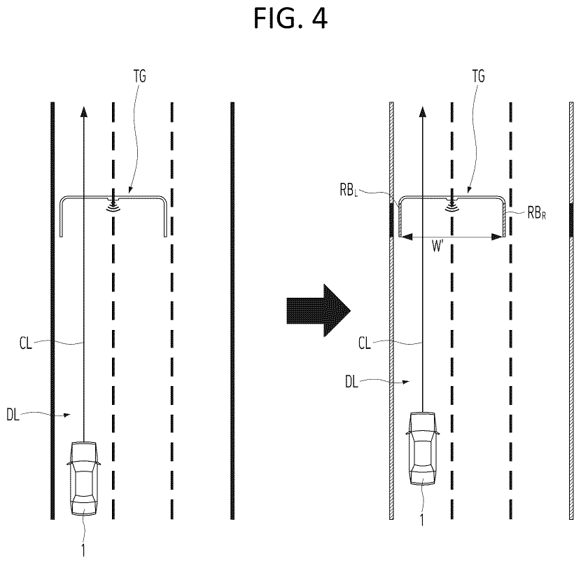

FIG. 4 is a diagram for explaining a method of calculating a width of a tollgate in a multi-lane ETC lane in the method for controlling the vehicle based on ETC lane classification according to the embodiment of the present disclosure.

Referring to FIG. 4, in the method for controlling a vehicle based on ETC lane classification according to an embodiment of the present disclosure, when the ego vehicle 1 is driving on a highway, and is driving at a tollgate TG section, it may be determined using the position information whether the driving lane DL where the ego vehicle 1 is driving is an ETC lane.

Further, the center line CL of the lane where the ego vehicle is to drive may be extracted through the navigation route based on the driving lane of the ego vehicle and navigation information.

Referring to the right diagram of FIG. 4, after the center line CL is extracted, the road boundaries RB_{L}, RB_{R} of the tollgate TG section may be detected, and the width W′ of the road boundary may be calculated by summing the lateral distance between the center line CL and the left road boundary RB_{L} and the lateral distance between the center line CL and the right road boundary RB_{R}.

With determining whether the calculated width W′ is greater than or equal to a predetermined threshold value, if it is greater than or equal to the predetermined threshold value, as shown in FIG. 4, it may be determined that the ETC lane is a multi-lane ETC lane, and accordingly, the highway AD system of the ego vehicle 1 may be maintained in the ON state.

As described above, according to the method for controlling a vehicle based on ETC lane classification according to the embodiment of the present disclosure, by classifying whether the ETC lane is multi-lane before passing through the tollgate and controlling the operation of the highway AD system, the risk of collision with the road boundary caused by the operation of the highway AD system in a single-lane ETC lane can be minimized, thereby promoting the driver's safe driving.

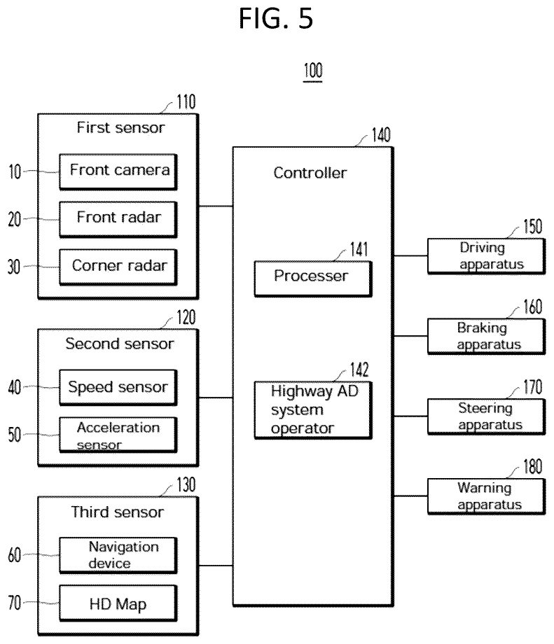

FIG. 5 is a control configuration diagram schematically showing a configuration of a system for controlling a vehicle based on ETC lane classification according to embodiments of the present disclosure.

Referring to FIG. 5, a system for controlling a vehicle based on ETC lane classification 100 according to an embodiment of the present disclosure may comprise: a first sensor 110 configured to detect surroundings of an ego vehicle; a second sensor 120 configured to detect body information of the ego vehicle; a third sensor 130 configured to provide navigation information and High-Definition Map (HD Map) information; and a controller 140 configured to control the operation of the highway AD system of the ego vehicle based on data from at least one of the first sensor 110, the second sensor, or the third sensor 130.

Further, the controller 140 may comprise at least one processor 141 and a highway Autonomous Driving (AD) system operator 142.

Further, the controller 140 may determine whether the driving lane of the ego vehicle is an ETC lane, e.g., in case that the ego vehicle is driving at a tollgate section, and if it is the ETC lane, the controller 140 may determine whether it is a multi-lane ETC lane, and may control the operation of the highway AD system of the ego vehicle by the highway AD system operator 142 based on whether it is a multi-lane ETC lane.

Further, the controller 140 may extract the center line of the lane where the ego vehicle is to drive through the navigation route based on the driving lane of the ego vehicle and navigation information. Further, the controller 140 may calculate the width of the tollgate based on the lateral distance between the center line and the road boundaries on both sides of the tollgate.

Further, the controller 140 may determine that it is a multi-lane ETC lane if the width of the tollgate is equal to or greater than a predetermined threshold value, and determine that it is a single-lane ETC lane if the width of the tollgate is less than the predetermined threshold value.

Further, the controller 140 may control the highway AD system to be in the ON state by the highway AD system operator 142 if it is determined to be a multi-lane ETC lane, and control the highway AD system to be in the OFF state by the highway AD system operator 142 if it is determined to be a single-lane ETC lane.

The first sensor 110 may include at least one of a front camera 10, a front radar 20, or a corner radar 30 for detecting the surroundings of the ego vehicle. However, it is not limited thereto, and may include other types of sensors for detecting the vehicle's surroundings, such as ultrasonic sensors, lidar sensors, etc.

The second sensor 120 may include at least one of a speed sensor 40 or an acceleration sensor 50 for detecting body information of the ego vehicle. However, it is not limited thereto, and may include other sensors for detecting the ego vehicle's body information, such as a steering angle sensor, a steering torque sensor, etc.

Further, the third sensor 130 may include a navigation device 60 that provides navigation information to the ego vehicle, and an High-Definition (HD) Map 70 that provides high-definition map information. The ego vehicle may confirm that the ego vehicle is driving at a tollgate section based on the navigation information from the navigation device 60, and may determine whether the driving lane of the ego vehicle is an ETC lane based on position information of the ego vehicle and map information from the navigation device 60 or map information from the HD Map 70.

Further, information regarding the left road boundary and the right road boundary used in calculating the width of the tollgate in the embodiment of the present disclosure may be information provided by the HD Map 70.

Further, the controller 140 may be connected to a driving apparatus 150 configured to control the acceleration driving of the ego vehicle, a braking apparatus 160 configured to control the deceleration driving of the ego vehicle, and a steering apparatus 170 configured to control the lateral driving of the ego vehicle.

Accordingly, if determined to be a multi-lane ETC lane and the highway AD system is in the ON state by the highway AD system operator 142, the controller 140 may control the ego vehicle to perform the highway AD function by controlling at least one of the driving apparatus 150, the braking apparatus 160, or the steering apparatus 170.

Further, the controller 140 may be connected to a warning apparatus 180 configured to provide a notification to the driver of the ego vehicle.

If it is determined that the driving lane is a single-lane ETC lane, the controller 140 may control the warning apparatus 180 to provide a notification to the driver that the highway AD system is switching to the OFF state.

Further, after providing the notification for a predetermined time by the warning apparatus 180, the controller 140 may control the highway AD system operator 142 to transfer control authority to the driver of the ego vehicle.

Meanwhile, the method for controlling the vehicle based on ETC lane classification according to the embodiment of the present disclosure performed by the controller 140 has been described in detail above, so a detailed description thereof will be omitted here.

The disclosed embodiments may also be implemented as a computer-readable program on a computer-readable recording medium in order to be executed by a computer. A computer-readable recording medium may be a non-transitory computer-readable recording medium, such as a data storage device capable of storing data that may be read by a processor/microprocessor.

Examples of computer-readable recording media may include hard disk drives (HDD), solid-state drives (SSD), silicon disk drives (SDD), read-only memory (ROM), CD-ROM, magnetic tape, floppy disks, optical data storage devices, etc.

According to the above-described embodiments of the present disclosure, it is possible to provide a method and system for controlling a vehicle that can increase the driving safety of the driver by controlling the operation of the highway autonomous driving system to be On/Off through the multi-lane/single-lane classification of the Electronic Toll Collection (ETC) lanes in the highway tollgate section.

Moreover, according to the present disclosure, by enabling system control through the classification of the ETC lanes, the risk in vehicle driving according to the highway autonomous driving system can be minimized, and thus, it is possible to further improve the system performance in the development of the highway autonomous driving system.

The above description of the present disclosure is for illustrative purposes, and those skilled in the art may understand that it can be easily modified into other specific forms without changing the technical spirit or essential features of the present disclosure. Therefore, the embodiments described above should be understood as illustrative in all respects and not limiting. For example, each component described as a single type may be implemented in a distributed manner, and similarly, components described as distributed may be implemented in a combined form.

The scope of the present disclosure is indicated by the following claims rather than the above detailed description, and all changes or modifications derived from the meaning and scope of the claims and equivalent concepts should be interpreted to be included in the scope of the present disclosure.

### EXPLANATION OF REFERENCE

1: Ego vehicle
DL: Driving lane
CL: Center line
TG: Tollgate
RB_{L}, RB_{R}: Road boundary
W, W′: Width between road boundaries
100: System for controlling vehicle based on ETC lane classification
110: First sensor
120: Second sensor
130: Third sensor
140: Controller
141: Processor
142: Highway AD system operator
150: Driving apparatus
160: Braking apparatus
170: Steering apparatus
180: Warning apparatus

1. A method for controlling a vehicle based on Electronic Toll Collection (ETC) lane classification, comprising:
determining whether a driving lane of an ego vehicle is an Electronic Toll Collection (ETC) lane;
if the driving lane of the ego vehicle is the ETC lane, determining whether the ETC lane is a multi-lane ETC lane; and
controlling operation of a highway autonomous driving (AD) system of the ego vehicle based on whether the ETC lane is the multi-lane ETC lane.

2. The method of claim 1, wherein the determining of whether the driving lane is the ETC lane comprises:
determining whether the lane in which the ego vehicle is driving is the ETC lane using position information of the ego vehicle.

3. The method of claim 1, wherein the determining of whether the ETC lane is the multi-lane ETC lane comprises:
extracting a center line of a lane where the ego vehicle is to drive, based on the driving lane of the ego vehicle and a navigation route according to navigation information.

4. The method of claim 3, wherein the determining of whether the ETC lane is the multi-lane ETC lane further comprises:
detecting positions of a left road boundary and a right road boundary of a tollgate based on road boundary information; and
calculating a width of the tollgate by summing a lateral distance between the center line and the left road boundary and a lateral distance between the center line and the right road boundary.

5. The method of claim 4, wherein the determining of whether the ETC lane is the multi-lane ETC lane comprises:
determining that the driving lane of the ego vehicle is the multi-lane ETC lane if the width of the tollgate is equal to or greater than a predetermined threshold value; and
determining that the driving lane of the ego vehicle is a single-lane ETC lane if the width of the tollgate is less than the predetermined threshold value.

6. The method of claim 4, wherein the road boundary information regarding the left road boundary and the right road boundary is information provided by a High-Definition Map (HD Map).

7. The method of claim 5, wherein the controlling of the operation of the highway AD system comprises:
controlling the highway AD system to maintain an ON state if it is determined that the driving lane of the ego vehicle is the multi-lane ETC lane.

8. The method of claim 5, wherein the controlling of the operation of the highway AD system comprises:
controlling the highway AD system to switch to an OFF state if it is determined that the driving lane of the ego vehicle is the single-lane ETC lane.

9. The method of claim 8, further comprising:
if it is determined that the driving lane of the ego vehicle is the single-lane ETC lane, providing, by a warning apparatus installed in the ego vehicle, a notification to a driver of the ego vehicle that the highway AD system is switching to the OFF state.

10. The method of claim 9, further comprising:
after providing the notification to the driver for a predetermined time, transferring control authority to the driver.

11. A system for controlling a vehicle based on Electronic Toll Collection (ETC) lane classification, comprising:
a first sensor configured to detect surroundings of an ego vehicle;
a second sensor configured to detect body information of the ego vehicle;
a third sensor configured to provide navigation information and High-Definition Map (HD Map) information; and
a controller comprising at least one processor and a highway Autonomous Driving (AD) system operator,
wherein the controller is configured to determine whether an Electronic Toll Collection (ETC) lane is a multi-lane ETC lane if a driving lane of the ego vehicle is the ETC lane, and control operation of the highway AD system of the ego vehicle by the highway AD system operator based on whether the ETC lane is the multi-lane ETC lane.

12. The system of claim 11, wherein the controller is configured to extract a center line of a lane where the ego vehicle is to drive, based on the driving lane of the ego vehicle and a navigation route according to the navigation information provided by the third sensor.

13. The system of claim 12, wherein the controller is configured to:
detect positions of a left road boundary and a right road boundary of a tollgate based on road boundary information from the HD Map information provided by the third sensor; and
calculate a width of the tollgate by summing a lateral distance between the center line and the left road boundary and a lateral distance between the center line and the right road boundary.

14. The system of claim 13, wherein the controller is configured to:
determine that the driving lane of the ego vehicle is the multi-lane ETC lane if the width of the tollgate is greater than or equal to a predetermined threshold value; and
determine that the driving lane of the ego vehicle is a single-lane ETC lane if the width of the tollgate is less than the predetermined threshold value.

15. The system of claim 14, wherein the controller is configured to control the highway AD system operator to maintain the highway AD system in an ON state if it is determined that the driving lane of the ego vehicle is the multi-lane ETC lane, and switch the highway AD system to an OFF state if it is determined that the driving lane of the ego vehicle is the single-lane ETC lane.

16. The system of claim 11, wherein the first sensor comprises at least one of a front camera, a front radar, or a corner radar, and the second sensor comprises at least one of a speed sensor or an acceleration sensor.

17. The system of claim 14, wherein the third sensor comprises a navigation device configured to provide the navigation information, and a High-Definition (HD) Map configured to provide the HD Map information, and the road boundary information regarding the left road boundary and the right road boundary is provided by the HD Map.

18. The system of claim 14, wherein the controller is connected to a warning apparatus configured to provide a notification to a driver of the ego vehicle, and the controller is configured to control the warning apparatus to provide a notification that the highway AD system is switching to the OFF state when it is determined that the driving lane of the ego vehicle is the single-lane ETC lane.

19. The system of claim 18, wherein the controller is configured to control the highway AD system operator to transfer control authority to the driver after the notification has been provided for a predetermined time by the warning apparatus.

20. A non-transitory computer-readable recording medium that records a program for executing a method for controlling a vehicle based on Electronic Toll Collection (ETC) lane classification on a computer, the method comprising:
determining whether a driving lane of an ego vehicle is an Electronic Toll Collection (ETC) lane;
if the driving lane of the ego vehicle is the ETC lane, determining whether the ETC lane is a multi-lane ETC lane; and
controlling operation of a highway autonomous driving (AD) system of the ego vehicle based on whether the ETC lane is the multi-lane ETC lane.
